(19) United States
(12) Patent Application Publication
(10) Pub. No.: US 2024/0343093 A1
(43) Pub. Date: Oct. 17, 2024

(54) CABIN AIR CONTROL SYSTEM WITH SINGLE ADSORPTION UNIT

(71) Applicant: MANN+HUMMEL GmbH, Ludwigsburg (DE)

(72) Inventors: Jon CHAI, Ningxia (CN); Lei WU, Shanghai (CN); Gelase MBADINGA MOUANDA, Sachsenheim (DE)

(21) Appl. No.: 18/597,852

(22) Filed: Mar. 6, 2024

Related U.S. Application Data
(63) Continuation of application No. PCT/CN2023/087962, filed on Apr. 13, 2023.

(51) Int. Cl. B60H 1/32

(52) U.S. Cl. CPC B60H 1/32014

(57) ABSTRACT

A cabin air control system comprises an upper housing including a first end and an opposite second end, and a lower housing including a first end, an opposite second end, an air inlet passage with an inlet opening at the first end of the lower housing, and a regeneration air chamber communicating with the air inlet passage via a regeneration air port. The system further includes a single adsorption unit configured to adsorb moisture and/or carbon dioxide, a heater disposed in the regeneration air chamber, the heater being configured to heat air before being delivered to the adsorption unit, and the heated air being used to regenerate the adsorption unit, and a flap control assembly configured to switch between an adsorption mode and a regeneration mode.

### CROSS-REFERENCE TO RELATED APPLICATION

This application is a continuation application of International Application No. PCT/CN2023/087962 filed on Apr. 13, 2023, the entire disclosure of which is incorporated herein by reference for all purposes.

### BACKGROUND

The present invention relates to a Heating, Venting, and Air Conditioning (HVAC) system for a vehicle, and more specifically to a cabin air control system for HVAC system.

The HVAC system can be operated in an external circulation mode or in an air recirculation (i.e., internal circulation) mode. The power consumed by the HVAC system of electric vehicles is mostly between 1-2 KW, that is, every hour of air conditioning will reduce about 10.9 km of range. If the vehicle turns on the external circulation but under the maximum air volume conditions, additional 7 km of range will be reduce every hour, that is, if the HVAC system turns on external circulation mode, the vehicle is in the external circulation mode, the HVAC system will reduce 17.9 km of range per hour. This will greatly reduce the range of electric vehicles.

If the HVAC system is in the air recirculation mode, the power consumed will be greatly reduced. However, adults normally emit about 30 g/hour of water and about 40 g/hour of carbon dioxide by breathing. If the HVAC system is always in air recirculation mode while the vehicle is moving, the water vapor emitted by the human body will cause fogging on the glass of the vehicle, which will bring unpredictable danger to the driver and passengers of the vehicle. If the defogging mode is continuously turned on, it will increase the power consumption and reduce the range of the vehicle. Moreover, in the air recirculation mode, the CO2 inside the vehicle will continue to increase, which will cause the driver to be sleepy during driving, which will bring potential danger to the normal operation of the vehicle.

At present, there is proposed a double adsorption unit structure including a first adsorption unit and a second adsorption unit. However, the double adsorption unit structure has a large volume, which increases the difficulty of vehicle layout; the weight thereof is heavier, and the double adsorption unit structure itself needs to add more components to strengthen the structure; in addition, the cost is high, and the double adsorption unit requires two heaters and two motors to be managed separately.

To this end, it is desirable to develop a single adsorption unit structure, which ensures performance, has relatively small size, has relatively light weight, uses a single heater and a single motor to achieve operation control, reduces the manufacturing cost, greatly improves the compatibility of the air control system of the vehicle, and at the same time meets the basic function of vehicle energy saving, thereby improving the market competitiveness of the system.

### SUMMARY

Objects of the present disclosure are to provide an integrated cabin air recirculation system, which is simple in structure, reduces the number of components and is easy to assembly.

In one aspect, a cabin air control system is provided. The cabin air control system comprises: an upper housing including a first end and an opposite second end; a lower housing including: a first end; an opposite second end; an air inlet passage with an inlet opening at the first end of the lower housing; and a regeneration air chamber communicating with the air inlet passage via a regeneration air port, wherein the upper housing and the lower housing together defines an adsorption unit chamber above the regeneration air chamber and communicating with the air inlet passage via an adsorption air port, and the upper housing further includes an outlet passage, an outlet opening and an exhaust conduit, the outlet passage selectively communicating with the outlet opening and the exhaust conduit; a single adsorption unit disposed in the adsorption unit chamber, the adsorption unit being configured to adsorb moisture and/or carbon dioxide; a heater disposed in the regeneration air chamber, the heater being configured to heat air before being delivered to the adsorption unit, and the heated air being used to regenerate the adsorption unit; and a flap control assembly configured to switch between an adsorption mode and a regeneration mode, the flap control assembly including an inlet flap configured to be rotated between a first inlet position corresponding to the adsorption mode and a second inlet position corresponding to the regeneration mode, wherein, in the first inlet position, the adsorption air port is open and the regeneration air port is closed by the inlet flap, so that the air flows into the adsorption unit chamber and bypasses the heater, and in the second inlet position, the adsorption air port is closed by the inlet flap and the regeneration air port is open, so that the air flows into the regeneration air chamber, through the heater and into the adsorption unit chamber, and is heated to regenerate the adsorption unit.

Preferably, the flap control assembly further includes an outlet flap configured to be rotated between a first outlet position corresponding to the adsorption mode and a second outlet position corresponding to the regeneration mode. In the first outlet position, the outlet opening is open and the exhaust conduit is closed by the outlet flap, so that adsorbed and/or purified air flows into a cabin via the outlet opening, and in the second outlet position, the outlet opening is closed by the outlet flap and the exhaust conduit is open, so that exhaust including gas and water after regeneration flows to an environment through the exhaust conduit.

Preferably, the inlet flap and the outlet flap are connected by a link, so that the inlet flap and the outlet flap are driven by a single drive mechanism.

Preferably, the flap control assembly further includes an outlet flap coupling and an inlet flap coupling. The outlet flap coupling is fixedly connected with the outlet flap and is rotatably connected with the drive mechanism, the inlet flap coupling is fixedly connected with the inlet flap, the outlet flap coupling is provided with a first eccentric pin, the inlet flap coupling is provided with a second eccentric pin, and the link is connected to the first eccentric pin at one end thereof and is connected to the second eccentric pin at the other end thereof, so that when the outlet flap is rotated by the drive mechanism to the first outlet position or the second outlet position, the inlet flap is also rotated to the corresponding first inlet position or second inlet position via the link.

Preferably, the outlet flap is provided with a blocking pad at an end remote to the drive mechanism. In the first outlet position, the blocking pad blocks the exhaust conduit, and in the second outlet position, the blocking pad does not block the exhaust conduit.

Preferably, the adsorption unit includes water vapor adsorption material.

Preferably, the adsorption unit includes carbon dioxide adsorption material.

Preferably, the adsorption unit includes volatile matter adsorption material.

Preferably, the heater includes a seal flange and a seal ring extending circumferentially around the seal flange. When the heater is installed in place in the lower housing, the seal ring seals against corresponding structure of the lower housing.

Preferably, the heater is provided with at least one temperature sensor configured to effectively monitor temperature change of the heater to prevent accidents caused by heater overheating and failure caused by heater failure and to control regeneration temperature.

By means of the structure design of the single adsorption unit, the cabin air control system of the present invention is simple in structure, reduces the number of components and the volume of the cabin air control system and is easy to assembly while ensuring performance of the cabin air control system, which greatly improves the vehicle compatibility of the cabin air control system.

In addition, by means of the structure design of the single adsorption unit, the weight of the cabin air control system of the present invention is relatively light, while ensuring performance of the cabin air control system, which reduces the production cost and facilitates the installation and maintenance of the cabin air control system on the whole vehicle

The cabin air control system of the present invention adopts a single heater to realize operational control, which reduces the cost of the cabin air control system and enhances the market competitiveness of the cabin air control system.

In addition, the flap control assembly of the cabin air control system of the present invention adopts a single motor to drive both the inlet flap and the outlet flap, which reduces the cost of the cabin air control system and enhances the market competitiveness of the cabin air control system.

The cabin air control system is integrated with a temperature detection sensor, which can effectively monitor temperature change of the heater and to prevent accidents caused by heater overheating and failure caused by heater failure as well as to control regeneration temperature.

The distance between the heater and the adsorption unit is relatively close, which reduces the heat loss of the heated air, improves the heat utilization of during system regeneration, shortens the time for regeneration, and improves the efficiency of regeneration.

The cabin air control system uses a single adsorption unit, a single motor and a single heater, which together reduce the complexity control logic, and reduce the control cost of the cabin air control system.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings.

FIG. 1 is a schematic diagram of a cabin air control system of the present invention.

FIG. 2 is a schematic structural explosive diagram of the cabin air control system of the present invention.

FIG. 3 is a schematic structural explosive diagram of a flap control assembly of the cabin air control system of the present invention.

FIG. 4 is a top view of the cabin air control system of the present invention.

FIG. 5 is a front view of the cabin air control system of the present invention.

FIG. 6 is a side view of an upper housing and a lower housing of the cabin air control system of the present invention.

FIG. 7 schematically illustrates in cross-sectional view an adsorption mode of the cabin air control system of the present invention.

FIG. 8 schematically illustrates in cross-sectional view a regeneration mode of the cabin air control system of the present invention.

FIG. 9 is a schematic perspective diagram of a heater of the cabin air control system of the present invention.

FIG. 10 is a schematic perspective diagram of a flap control assembly of the cabin air control system of the present invention.

FIG. 11 is a schematic partial perspective diagram of the cabin air control system of the present invention wherein the outlet flap is located at a first outlet position corresponding to the adsorption mode.

FIG. 12 is a schematic partial perspective diagram of the cabin air control system of the present invention wherein the outlet flap is located at a second outlet position corresponding to the regeneration mode.

### DETAILED DESCRIPTION

As used herein, words such as “up”, “down”, “left”, and “right” used herein to define orientations generally refer to and are understood as orientations in association with the drawings and orientations in actual application.

As used herein, the term “vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles (ATV), motorcycles, farm equipment, watercraft, aircraft, etc. In an example, an electric vehicle includes a vehicle body with a passenger cabin, multiple road wheels mounted to the vehicle body, and other standard original equipment. An electrified powertrain contains one or more vehicle-mounted traction motors that operate alone (e.g., for FEV powertrains) or in conjunction with an internal combustion engine assembly (e.g., for HEV powertrains) to selectively drive one or more of the road wheels and thereby propel the vehicle.

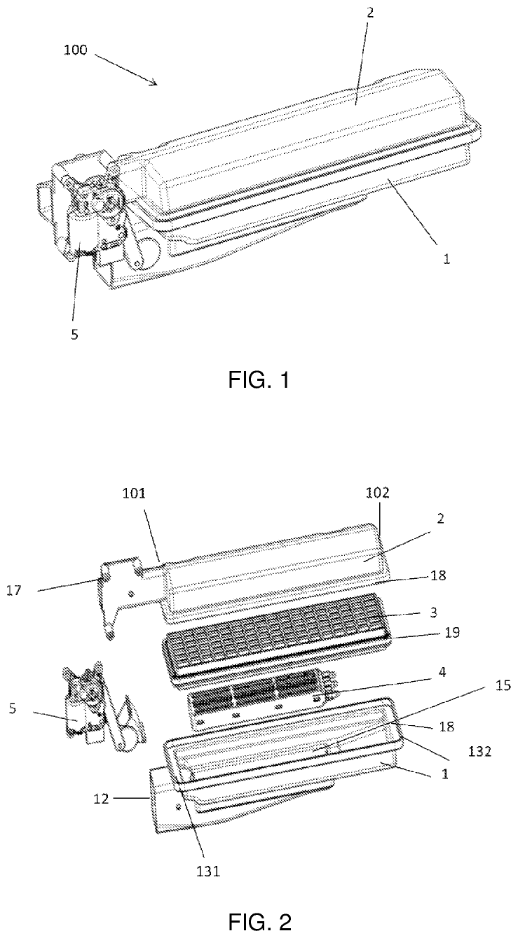

Referring now to the drawings, wherein like reference numbers refer to like features throughout the several views, FIG. 1 is a schematic diagram of a cabin air control system 100 of the present invention; FIG. 2 is a schematic structural explosive diagram of the cabin air control system 100 of the present invention.

The cabin air control system 100 may comprises an upper housing 2; a lower housing 1; a single adsorption unit 3; a heater 4; and a flap control assembly 5 configured to switch between an adsorption mode and a regeneration mode. The cabin air control system 100 may comprise other components as needed, such as a controller, at least one sensor, etc., without departing the scope of the disclosure. By means of the structure design of the single adsorption unit 3, the cabin air control system 100 of the present invention is simple in structure, reduces the number of components and the volume of the cabin air control system 100 and is easy to assembly while ensuring performance of the cabin air control system 100, which greatly improves the vehicle compatibility of the cabin air control system 100. In addition, by means of the structure design of the single adsorption unit 3, the weight of the cabin air control system 100 of the present invention is relatively light, while ensuring performance of the cabin air control system 100, which reduces the production cost and facilitates the installation and maintenance of the cabin air control system 100 on the whole vehicle. The cabin air control system 100 of the present invention adopts a single heater to realize operational control, which reduces the cost of the cabin air control system 100 and enhances the market competitiveness of the cabin air control system 100.

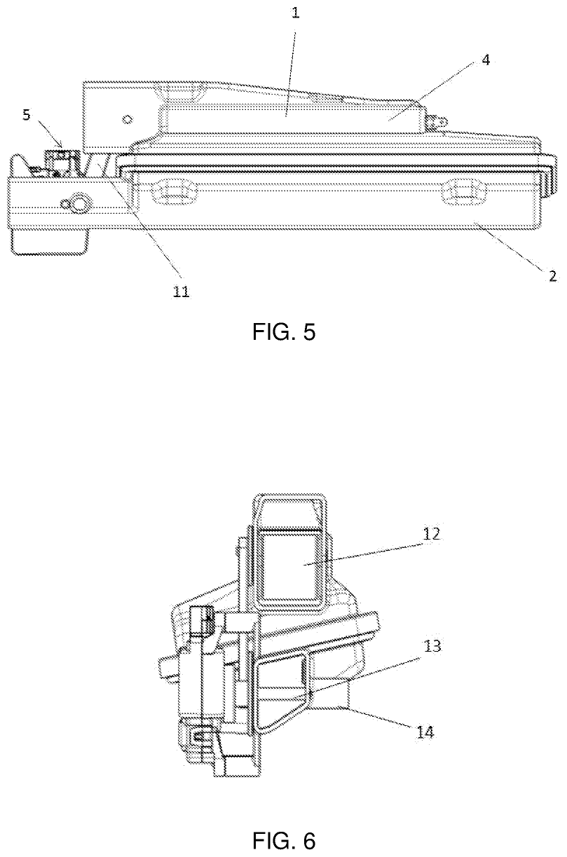

FIG. 4 is a top view of the cabin air control system 100 of the present invention. FIG. 5 is a front view of the cabin air control system 100 of the present invention. FIG. 6 is a side view of an upper housing 2 and a lower housing 1 of the cabin air control system 100 of the present invention.

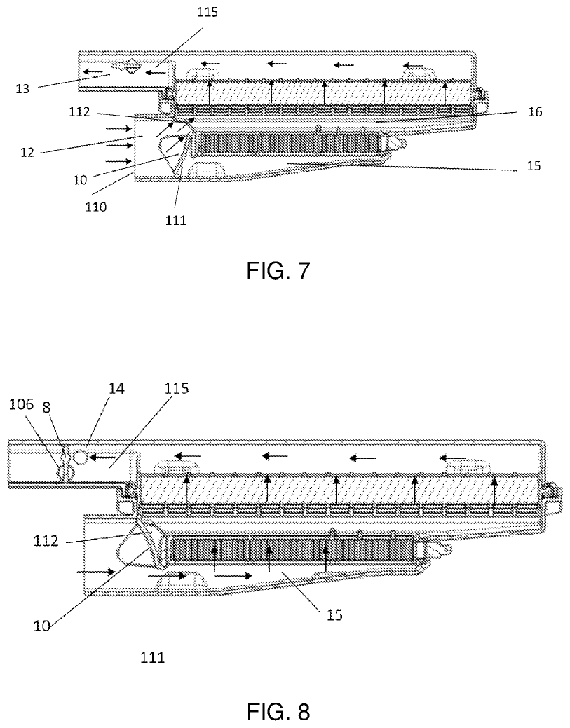

As a non-limiting example, the lower housing 1 may include a first end 131 and an opposite second end 132; an air inlet passage 12 with an inlet opening 110 (FIG. 7) at the first end 131 of the lower housing 1; and a regeneration air chamber 15 communicating with the air inlet passage 12 via a regeneration air port 111.

As a non-limiting example, the lower housing 1 may further include a mounting mechanism for the heater 4, to mount and fix the heater 4. The lower housing 1 may further include an installation structure for an inlet flap 10, to install the inlet flap 10 to ensure the normal control and sealing function of the inlet flap 10. The lower housing 1 may comprise other components as needed, without departing the scope of the disclosure.

As a non-limiting example, the upper housing 2 may include a first end 101 and an opposite second end 102. As a non-limiting example, the upper housing 2 and the lower housing 1 together define an adsorption unit chamber 16 above the regeneration air chamber 15 and communicating with the air inlet passage 12 via an adsorption air port 112. The upper housing 2 may further include an outlet passage 115, an outlet opening 13 and an exhaust conduit 14, the outlet passage 115 selectively communicates with the outlet opening 13 and the exhaust conduit 14.

In addition, the upper housing 2 may further include a motor positioning and mounting structure 17, to locate and install a drive mechanism 6. The upper housing 2 may further include an outlet flap installation structure, to install the outlet flap 8 to ensure the normal control and sealing function of the outlet flap 8.

The lower housing 1 and the upper housing 2 may further include an installation and sealing structure 18 of the adsorption unit 3, to install and fix the adsorption unit 3 and cooperate with the sealing strip 19 on the adsorption unit 3 to realize the sealing of the cabin air control system against the environment. At the same time, the installation and sealing structure 18 plays the role of separating a humid side from a dry side.

The adsorption unit 3 is disposed in the adsorption unit chamber 16, and configured to adsorb moisture and/or carbon dioxide. The adsorption unit 3 may be filled with water vapor adsorption material, carbon dioxide adsorption material, volatile adsorption material or adsorption material for absorbing other harmful substances according to customer needs. As a non-limiting example, the adsorption material may include resin, which has a certain adsorption capacity at room temperature, and has desorption ability at a temperature of 80-120° C. By using the properties of low-temperature adsorption and high-temperature desorption of resin, the air quality in the cabin is well controlled. However, as will be understood by those skilled in the art, the adsorption material may be made from any suitable material, without departing the scope of the disclosure.

The heater 4 is disposed in the regeneration air chamber 15 and is configured to heat air before being delivered to the adsorption unit 3, heated air is used to regenerate the adsorption unit 3.

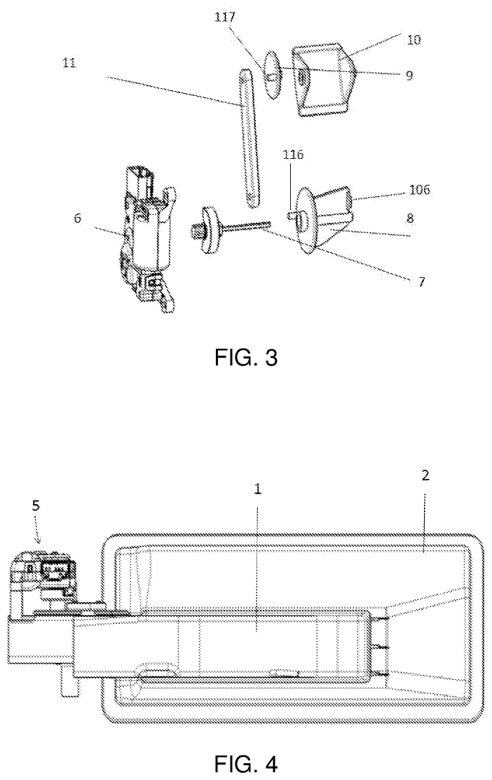

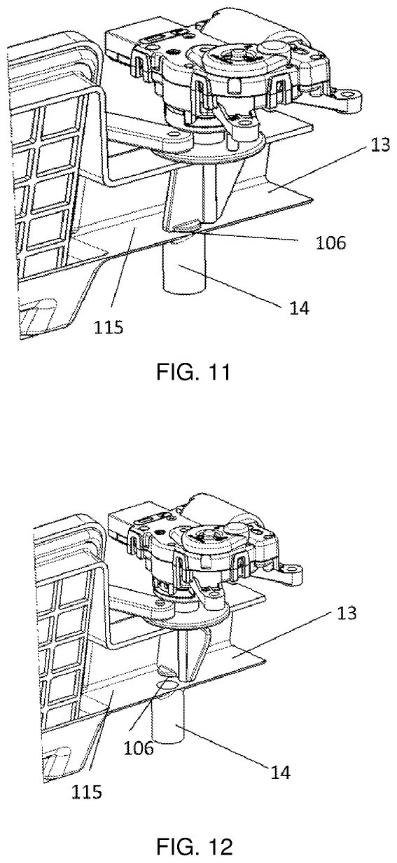

FIG. 3 is a schematic structural explosive diagram of a flap control assembly 5 of the cabin air control system 100 of the present invention. FIG. 10 is a schematic perspective diagram of a flap control assembly 5 of the cabin air control system 100 of the present invention. FIG. 11 is a schematic partial perspective diagram of the cabin air control system 100 of the present invention wherein the outlet flap 8 is located at a first outlet position corresponding to the adsorption mode. FIG. 12 is a schematic partial perspective diagram of the cabin air control system 100 of the present invention wherein the outlet flap 8 is located at a second outlet position corresponding to the regeneration mode.

As a non-limiting example, the flap control assembly 5 comprises an inlet flap 10 configured to be rotated between a first inlet position corresponding to the adsorption mode and a second inlet position corresponding to the regeneration mode. In the first inlet position, the adsorption air port 112 is open and the regeneration air port 111 is closed by the inlet flap 10, so that the air flows into the adsorption unit chamber 16 and bypasses the heater 4; in the second inlet position, the adsorption air port 112 is closed by the inlet flap 10 and the regeneration air port 111 is open, so that the air flows into the regeneration air chamber 15, through the heater 4 and into the adsorption unit chamber 16, and is heated to regenerate the adsorption unit 3.

The flap control assembly 5 further comprises an outlet flap 8 configured to be rotated between a first outlet position corresponding to the adsorption mode and a second outlet position corresponding to the regeneration mode. In the first outlet position for example as shown in FIG. 11, the outlet opening 13 is open and the exhaust conduit 14 is closed by the outlet flap 8, so that adsorbed and/or purified air flows into a cabin via the outlet opening 13; in the second outlet position for example as shown in FIG. 12, the outlet opening 13 is closed by the outlet flap 8 and the exhaust conduit 14 is open, so that the exhaust including gas and water after regeneration flows to the environment through the exhaust conduit 14.

As a non-limiting example, the inlet flap 10 and the outlet flap 8 are connected by a link 11, so that the inlet flap 10 and the outlet flap 8 are driven by a single drive mechanism. As a non-limiting example, the drive mechanism 6 is an electric motor, with control logic and sensor signals for fully automatic control. However, the drive mechanism 6 may also include any other suitable drive mechanism, such as a hydraulic motor, without departing the scope of the disclosure.

As a non-limiting example, the flap control assembly 5 further comprises an outlet flap coupling 7 and an inlet flap coupling 9, the outlet flap coupling 7 is fixedly connected with the outlet flap 8 and is rotatably connected with the drive mechanism, the inlet flap coupling 9 is fixedly connected with the inlet flap 10, the outlet flap coupling 7 is provided with a first eccentric pin 116, the inlet flap coupling 9 is provided with a second eccentric pin 117. The link 11 is connected to the first eccentric pin 116 at one end thereof and is connected to the second eccentric pin 117 at the other end thereof, so that when the outlet flap 8 is rotated by the drive mechanism to the first outlet position or the second outlet position, the inlet flap 10 is also rotated to corresponding first inlet position or second inlet position via the link 11.

The flap control assembly 5 of the cabin air control system 100 of the present invention adopts a single motor to drive both the inlet flap 10 and the outlet flap 8, which reduces the cost of the cabin air control system 100 and enhances the market competitiveness of the cabin air control system 100.

As will be understood by those skilled in the art, the flap control assembly 5 may also utilize other suitable configurations, for example, the inlet flap 10 may be rotatably connected with the drive mechanism via the inlet flap coupling 9 and the outlet flap 8 may be connected with the inlet flap 10 via a link, so that when the inlet flap 10 is rotated by the drive mechanism to the first inlet position or the second inlet position, the outlet flap 8 is also rotated to corresponding first outlet position or second outlet position via the link, without departing the scope of the disclosure.

FIG. 7 schematically illustrates in cross-sectional view an adsorption mode of the cabin air control system 100 of the present invention. FIG. 8 schematically illustrates in cross-sectional view a regeneration mode of the cabin air control system 100 of the present invention. The outlet flap 8 is provided with a blocking pad 106 at an end remote to the drive mechanism, in the first outlet position, the blocking pad 106 blocks the exhaust conduit 14; in the second outlet position, the blocking pad 106 does not block the exhaust conduit 14.

When the cabin air control system is in the adsorption mode (FIG. 7), air with high humidity and/or high concentration of CO2 to the air inlet passage 12 through an air conditioning fan (not shown), and then the air is transported to the adsorption unit 3 via the adsorption unit chamber 16 Air dehumidification and/or purification is carried out, and then the air flows through the outlet opening 13 and returns to the air conditioning system and is distributed to various areas of the cabin as desired.

When the cabin air control system is in regenerative mode (FIG. 8), the air is transported to the air inlet passage 12 through the air conditioning fan, and then the air is transported to the heater 4 via the regeneration air chamber 15. The heater 4 is in working condition, the air is heated to the set temperature, and then the heated air is delivered to the adsorption unit 3. The adsorption material in the adsorption unit 3 is regenerated. The exhaust including gas such as CO2 and water after regeneration flows to the environment through the exhaust conduit 14.

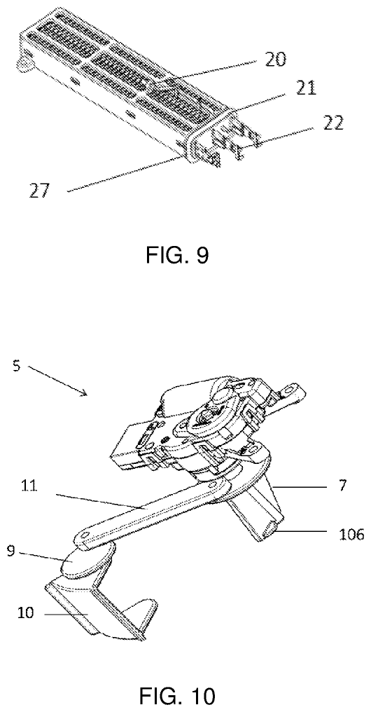

FIG. 9 is a schematic perspective diagram of a heater 4 of the cabin air control system 100 of the present invention. The heater 4 includes at least one temperature sensor 26, which can effectively monitor the temperature change of the heater 4 and prevent accidents caused by heater overheating and failure caused by heater failure as well as control regeneration temperature. As a non-limiting example, the heater 4 includes two temperature sensors 26. However, as will be understood by those skilled in the art, the heater 4 may include any suitable number of temperature sensors 26, without departing the scope of the disclosure.

The heater 4 further includes a seal flange 27 and a seal ring 21 extending circumferentially around the seal flange 27. When the heater 4 is installed in place in the lower housing 1, the seal ring 21 seals against corresponding structure of the lower housing 1. The heater 4 further includes a flange face, designed with a power plug interface 29, for connecting the heater 4 to the power supply. As will be understood by those skilled in the art, the heater 4 may comprise other components as needed, without departing the scope of the disclosure.

The cabin air control system 100 uses a single adsorption unit 3, a single motor and a single heater 4, which together reduce the complexity control logic, and reduce the control cost of the cabin air control system 100.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

1. A cabin air control system comprising:
an upper housing including a first end and an opposite second end;
a lower housing including:
a first end;
an opposite second end;
an air inlet passage with an inlet opening at the first end of the lower housing; and
a regeneration air chamber communicating with the air inlet passage via a regeneration air port,
wherein the upper housing and the lower housing together define an adsorption unit chamber above the regeneration air chamber and communicating with the air inlet passage via an adsorption air port, and
the upper housing further includes an outlet passage, an outlet opening and an exhaust conduit, the outlet passage selectively communicating with the outlet opening and the exhaust conduit;
a single adsorption unit disposed in the adsorption unit chamber, the adsorption unit being configured to adsorb moisture and/or carbon dioxide;
a heater disposed in the regeneration air chamber, the heater being configured to heat air before being delivered to the adsorption unit, and the heated air being used to regenerate the adsorption unit; and
a flap control assembly configured to switch between an adsorption mode and a regeneration mode, the flap control assembly including an inlet flap configured to be rotated between a first inlet position corresponding to the adsorption mode and a second inlet position corresponding to the regeneration mode,
wherein, in the first inlet position, the adsorption air port is open and the regeneration air port is closed by the inlet flap, so that the air flows into the adsorption unit chamber and bypasses the heater, and
in the second inlet position, the adsorption air port is closed by the inlet flap and the regeneration air port is open, so that the air flows into the regeneration air chamber, through the heater and into the adsorption unit chamber, and is heated to regenerate the adsorption unit.

2. The cabin air control system according to claim 1, wherein the flap control assembly further includes an outlet flap which is configured to be rotated between a first outlet position corresponding to the adsorption mode and a second outlet position corresponding to the regeneration mode,
in the first outlet position, the outlet opening is open and the exhaust conduit is closed by the outlet flap, so that adsorbed and/or purified air flows into a cabin via the outlet opening, and
in the second outlet position, the outlet opening is closed by the outlet flap and the exhaust conduit is open, so that exhaust including gas and water after regeneration flows to an environment through the exhaust conduit.

3. The cabin air control system according to claim 2, wherein the inlet flap and the outlet flap are connected by a link, so that the inlet flap and the outlet flap are driven by a single drive mechanism.

4. The cabin air control system according to claim 3, wherein the flap control assembly further includes an outlet flap coupling and an inlet flap coupling,
the outlet flap coupling is fixedly connected with the outlet flap and is rotatably connected with the drive mechanism,
the inlet flap coupling is fixedly connected with the inlet flap,
the outlet flap coupling is provided with a first eccentric pin,
the inlet flap coupling is provided with a second eccentric pin, and
the link is connected to the first eccentric pin at one end thereof and is connected to the second eccentric pin at the other end thereof, so that when the outlet flap is rotated by the drive mechanism to the first outlet position or the second outlet position, the inlet flap is also rotated to the corresponding first inlet position or second inlet position via the link.

5. The cabin air control system according to claim 4, wherein the outlet flap is provided with a blocking pad at an end remote to the drive mechanism,
in the first outlet position, the blocking pad blocks the exhaust conduit, and
in the second outlet position, the blocking pad does not block the exhaust conduit.

6. The cabin air control system according to claim 1, wherein the adsorption unit includes water vapor adsorption material.

7. The cabin air control system according to claim 1, wherein the adsorption unit includes carbon dioxide adsorption material.

8. The cabin air control system according to claim 1, wherein the adsorption unit includes volatile matter adsorption material.

9. The cabin air control system according to claim 1, wherein the heater includes a seal flange and a seal ring extending circumferentially around the seal flange, and
when the heater is installed in place in the lower housing, the seal ring seals against corresponding structure of the lower housing.

10. The cabin air control system according to claim 9, wherein the heater is provided with at least one temperature sensor configured to effectively monitor temperature change of the heater to prevent accidents caused by heater overheating and failure caused by heater failure and to control regeneration temperature.
